(19) United States
(12) Patent Application Publication
(10) Pub. No.: US 2004/0139618 A1
(43) Pub. Date: Jul. 22, 2004

(54) Wall cutter

(76) Inventor: George Lawrence O'Brien, Winthrop, MA (US)

Correspondence Address: Lambert & Associates, P.L.L.C., 92 State Street, Boston, MA, 02109-2004, US

(21) Appl. No.: 10/348,240

(22) Filed: Jan. 21, 2003

(51) Int. Cl. B23D 45/16

(52) U.S. Cl. 30/388

(57) ABSTRACT

A hand held wall cutter having handles, a drive unit, a housing enclosing a motor, and a circular cutting disc. A handle is attached to the housing at one of its ends. The drive unit is coupled to the housing at one of its ends and the circular cutting disc is attached to the drive unit's second end. Handles are attached to either side of the drive unit for controlling the device. The wall cutter enables cutting through of walls, ceilings and other substantially planar objects without previous invasion of the object.

### BACKGROUND OF INVENTION

In the areas of construction, house maintenance, house renovation or similar activity, it is necessary to cut or make holes in walls. Tools used to achieve such ends in the past have been sharp objects, chain saws or reciprocating saws. Sharp objects such as axes or hatchets have been used to make holes in walls, but are not able to cut cleanly and require a great deal of physical exertion. Chain saws have been used to cut through walls as well, however they do not cut cleanly and are difficult to control as one operates the device.

Reciprocating saws have also been useful as wall cutters, in that their blade can be controlled and used to slice through parts of walls. However, reciprocating saws have a major drawback in that they are unable to cut into a wall unless there is a hole already established, thereby allowing the blade to enter and position itself in a manner enabling it to cut. This somewhat defeats the purpose of a wall cutter where it is required that the wall already be cut in order for it to function properly. Moreover, the cutting means of the devices are close in proximity to the operator.

Moreover, with these devices it is difficult to cut into a ceiling or other hard to reach planar object such as a roof of an automobile or to cut an appreciable distance below the horizontal reach of the device, due to flaws inherent in the reciprocating design. For these reasons a device is needed which is easy to control, and does not require any previous invasion of a wall, and can reach difficult to reach planar objects such as ceilings and roofs of automobiles.

### SUMMARY OF THE INVENTION

The present invention is a device that advances the art of wall cutting. In one embodiment, the cutter is comprised of a motor enclosed in a housing. A handle is coupled to the housing in order for an operator to control and stabilize the device. A drive unit is coupled to the housing on one of its ends. The drive unit is approximately 2-3 times the length of the housing. An approximate length of the housing can be 10 inches while a standard length drive unit is approximately 2 or 3 feet in length. Additional handles are attached on either side of the drive unit for further control and stabilization. The handles fold outward from the drive unit for gripping by an operator when in use, and can be folded into the drive unit when not in use. A circular planar disc with means for cutting is attached to the drive unit. As well known in the art, the motor causes rotation of the disc, which can thereafter be used to cut through a wall, ceiling, floor, or similar object. The disc's means for cutting can be a sharpened edge, or cutting blade. The entire unit is to be hand held, with the circular planar disc to be at some distance from the operator, unlike prior hand held saws. Moreover, a high percentage of the disc edge is available for direct contact as compared to previous hand held units.

In another embodiment, the drive unit is elongated and has an approximate length that is about 3-10 times longer than the housing, or a length substantially beyond an operator's reach. A purpose for such a length is to enable an operator using the cutter to reach the ceiling while standing on the floor. Another embodiment is one where the drive unit is bent, where both straight sections before and after the bend are of similar length. Such a bend facilitates cutting of automobile roofs or similar objects that may otherwise be difficult to reach and controlled during cutting.

The object of this present invention is to enable the cutting through of walls or other planar objects in straight lines or in any manner preferred by an operator. The device enables one to cut through a wall without beforehand making a hole in the wall. An object of this device through several embodiments is to enable the device to reach planar objects that may otherwise be difficult, such as ceilings or floors, or the roof of a car.

These and other features, aspects and advantages of the present invention will become better understood with reference to the following description, claims, and accompanying drawings. Therefore the form of the invention as set out above should be considered illustrative and not as limiting the scope of the following claims.

### BRIEF DESCRIPTION OF DRAWINGS

FIG. 1 is a side view of an embodiment of the cutter.

FIG. 2 is a side view of the cutter with approximate proportions where the drive unit has a standard length.

FIG. 3 is a side view of the cutter with approximate proportions where the drive unit is elongated.

FIG. 4 is a top view of the cutter.

FIG. 5 is a side view of the cutter with a bent drive unit.

### DESCRIPTION OF THE INVENTION

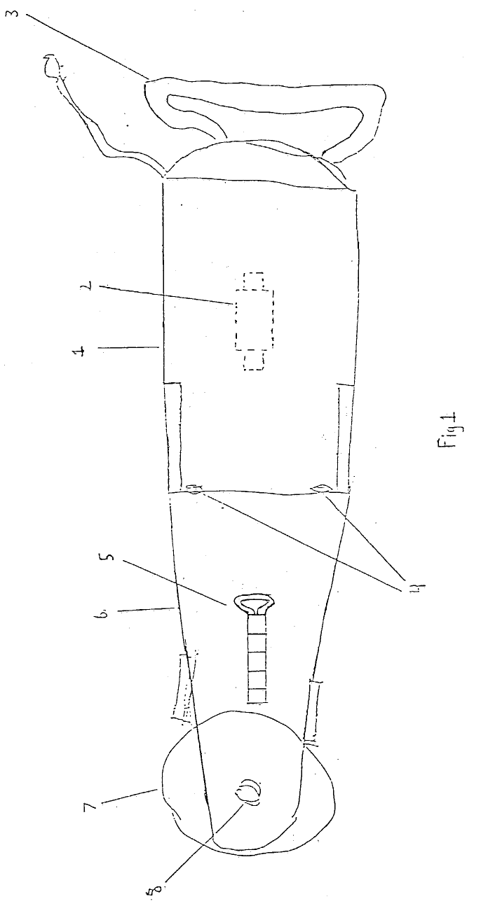

This invention represents a device for the cutting of walls. One embodiment is displayed in FIG. 1. Within a housing 1 is enclosed a motor 2, which is well known in the art for powering cutting devices. Attached to the housing is a handle 3 which can be used for control and stabilization of the device. A drive unit 6 has a means 4 for coupling to a second end of the housing 1. The driver can be either long, mid-sized or short depending on what is needed to perform a task. The drive unit has foldable handles 5 to be gripped by an operator for further control and stabilization. A substantially circular planar disc 7 is coupled centrally to a second end of the drive unit 6 by means 8. The disc 7 can have various means for cutting walls or similar objects.

The entire unit is to be hand held, with the circular planar disc 7 to be at some distance from the operator, unlike prior hand-held saws. Furthermore, due to the prominence of the blade, a high percentage of the cutting surface is available for directly cutting an object as compared to other hand held saws.

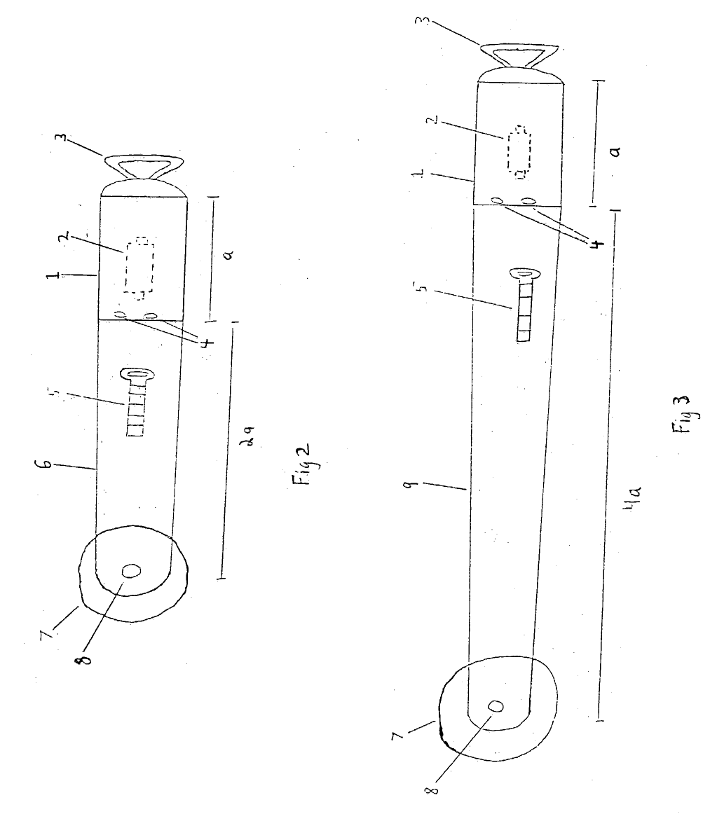

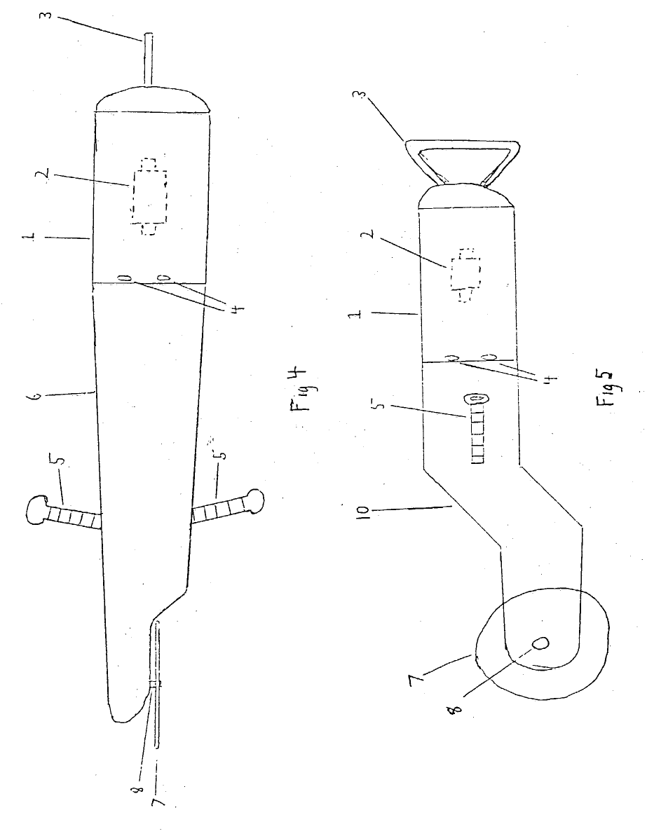

Another embodiment is shown in FIG. 3, where drive unit 9 is elongated as compared to a standard sized drive unit 6 in FIG. 2.

An additional embodiment is displayed in FIG. 5. This Embodiment shows the cutter with a bent drive unit 10 which is attached to the housing 1 by coupling means 4.

What is claimed is:

1. A cutting device comprising:
a housing with a motor therein, having a first end and a second end; wherein the housing has at least one handle affixed to the first end of the housing.
at least one drive unit, having a first end, an intermediate section, and a second end, wherein the first end of the drive unit has means for coupling to the second end of the housing;
foldable handles affixed to either side of the drive unit.
a substantially circular planar disc, having an edge and a central rotary axis, wherein the disc is coupled to the second end of the drive unit;
means for rotation of the disc around the central rotary axis of the disc, wherein the motor provides the power for rotation of the disc.

2. The cutting device of claim 1 wherein:
the substantially circular planar disc has means for cutting walls, ceilings or similar object.

3. The cutting device of claim 1 wherein:
the intermediate section of the drive unit has a straight shape.

4. The cutting device of claim 1 wherein:
the intermediate section of the drive unit has an elongated length substantially beyond an operator's reach.

5. The cutting device of claim 1 wherein:
the intermediate section of the drive unit is elongated.

6. The cutting device of claim 1 wherein:
the intermediate section of the drive unit has an extendable length.

7. The cutting device of claim 1 wherein:
the intermediate section of the drive unit has a bent shape.

8. The cutting device of claim 7 wherein:
the drive unit on the first and the second end of the drive unit is elongated.

9. A cutting device comprising:
a housing with a motor therein, having a first end and a second end; wherein the housing has at least one handle affixed to the first end of the housing.
a plurality of interchangeable drive units, wherein each drive unit has a first end, an intermediate section, and a second end, wherein the first end of each drive unit has means for coupling to the second end of the housing, whereby each drive is selectively mounted on the housing;
foldable handles affixed to either side of each of the plurality of drive units.
a substantially circular planar disc, having an edge and a central rotary axis, wherein the disc is coupled to the second end of the drive unit;
means for rotation of the disc around the central rotary axis of the disc, wherein the motor provides the power for rotation of the disc.

10. The cutting device of claim 9 wherein:
the intermediate section of the drive unit has a straight shape.

11. The cutting device of claim 9 wherein:
the intermediate section of the drive unit has an elongated length substantially beyond an operator's reach.

12 The cutting device of claim 9 wherein:
the intermediate section of the drive unit is elongated.

13. The cutting device of claim 9 wherein:
the intermediate section of the drive unit has an extendable length.

14. The cutting device of claim 9 wherein:
the substantially circular planar disc has means for cutting walls, ceilings or similar object.

15. The cutting device of claim 9 wherein:
the intermediate section of the drive unit has a bent shape.

16. The cutting device of claim 15 wherein:
the drive unit on the first and the second end of the drive unit is elongated.

17. A cutting device comprising:
a housing with a motor therein, having a first end and a second end; wherein the housing has at least one handle affixed to the first end of the housing.
a detachable short drive unit, having a first end, an intermediate section, and a second end, wherein the first end of the short drive unit has means for coupling to the second end of the housing;
a detachable elongated drive unit, having a first end, an intermediate section, and a second end, wherein the first end of the long drive unit has means for coupling to the second end of the housing;
a detachable, extendable drive unit, having a first end, an intermediate section, and a second end, wherein the first end of the long drive unit has means for coupling to the second end of the housing;
a detachable bent drive unit, having a first end, an intermediate section, and a second end, wherein the first end of the bent drive unit has means for coupling to the second end of the housing;
wherein the detachable drive units are interchangeable and may be interchangeably coupled to the housing;
foldable handles affixed to either side of each of the detachable drive units.
a substantially circular planar disc, having an edge and a central rotary axis, wherein the disc is coupled to the second end of the short, the long, the extendable, or the bent drive unit;
means for rotation of the disc around the central rotary axis of the disc, wherein the motor provides the power for rotation of the disc.

18. The cutting device of claim 17 wherein:
the substantially circular planar disc has means for cutting walls, ceilings or similar object.

19. The cutting device of claim 17 wherein:
the bent drive unit on the first and the second end of the drive unit is elongated.
